(19) United States
(12) Patent Application Publication
(10) Pub. No.: US 2020/0029168 A1
(43) Pub. Date: Jan. 23, 2020

(54) INTEROPERABLE DEVICE LOCATION

(71) Applicant: NANOPORT TECHNOLOGY INC., Markham, ON (CA)

(72) Inventors: TIMOTHY JING YIN SZETO, Mississauga (CA); Ashley Elizabeth HUFFMAN, Whitby (CA)

(21) Appl. No.: 16/304,837

(22) PCT Filed: May 26, 2017
(86) PCT No.: PCT/CA2017/050644

§ 371 Date: Nov. 27, 2018

Related U.S. Application Data
(60) Provisional application No. 62/342,541, filed on May 27, 2016.

(51) Int. Cl. H04W 4/02; H04W 8/00; G08B 3/10; G08B 5/22; H04W 4/33; G06F 16/9537

(52) U.S. Cl. CPC H04W 4/023; H04W 8/005; G06F 16/9537; G08B 5/22; H04W 4/33; G08B 3/10

(57) ABSTRACT

A method of locating interoperable devices at a location, comprising receiving from a guest device at the location a query over a network to a location server. The query includes an indicator of location of the guest device, and an identifier of the guest device. The method includes querying a data store, to identify a set of proximate interoperable devices at the location, using the indicator of location; identifying permitted proximate interoperable devices from the set of proximate interoperable devices, for which contact permission by the guest device has been granted; and dispatching a message over the network to each of the permitted proximate interoperable device causing them to emit a beacon signal, that is audible or visible at the location.

### CROSS-REFERENCE TO RELATED APPLICATIONS

This application claims priority to U.S. Provisional Application No. 62/342541 filed May 27, 2016, the contents of which are hereby incorporated by reference.

### TECHNICAL FIELD

This relates to mobile devices, and more particularly to locating other devices of interest that are in proximity to a mobile device.

### BACKGROUND

Mobile electronic devices are often interoperable wish other devices, and wish to establish connections to other devices. This is particularly so for mobile devices that are configured to establish physical (e.g. mechanical) connections to other devices. U.S. Pat. No. 9,312,633, the contents of which are hereby incorporated by reference, for example discloses devices capable of physical and electrical interconnection by way of magnetic connectors.

Although interconnection is often desirable, locating devices for interconnection is often difficult, particularly if the devices are mobile, or the environment in which they are operating is unfamiliar, or changing.

Accordingly, there remains a need for facilitating the interconnection of electronic, and particularly mobile, devices.

### SUMMARY

According to an aspect, there is provided a method of locating interoperable devices at a location, comprising receiving from a guest device at the location, a query over a network to a location server, the query including an indicator of location of the guest device, and an identifier of the guest device; querying a data store, to identify a set proximate interoperable devices at the location, using the indicator of location; identifying permitted proximate interoperable devices from the set of proximate interoperable devices, for which contact permission by the guest device has been granted; and dispatching a message over the network to each the permitted proximate interoperable device, causing each the permitted proximate device to emit a beacon signal, that is audible or visible at the location.

According to another aspect, there is provided a method of interconnecting first and second devices, each including a physical connector, the method comprising sending from the first device a near range query signal; receiving from a second device, an indicator that the second device is within a defined proximity of the first device; generating at the first device, an indicator of relative position of the second device to the first device, to allow the first device to be guided to the second device for interconnection by way of its physical connector.

Other features will become apparent from the drawings in conjunction with the following description.

### BRIEF DESCRIPTION OF THE DRAWINGS

In the figures which illustrate example embodiments,

FIG. 1 depicts multiple electronic devices, in communication with a network and server, exemplary of embodiments;

FIG. 2 schematically depicts two proximate devices, exemplary of embodiments;

FIG. 3 is a block diagram of an example device;

FIG. 4 is a block diagram of memory at the device of FIG. 3;

FIGS. 5A and 5C are flow charts of blocks performed at the device of FIG. 3;

FIGS. 5B and 5D are flow charts of blocks performed at the server of FIG. 1;

FIGS. 6A and 6B illustrates the devices of FIG. 1 in an environment proximate other devices;

FIG. 7 illustrates a screen of an example device of FIG. 1;

FIGS. 8A and 8B illustrates responding proximate devices in an environment; and

FIG. 9A-9D illustrate exemplary electronic devices in point to point communication.

### DETAILED DESCRIPTION

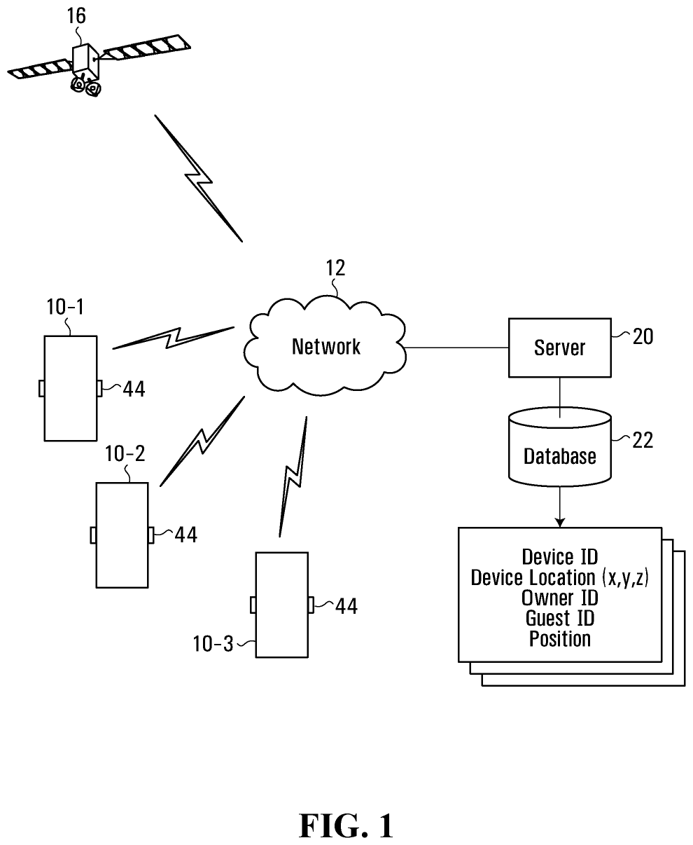

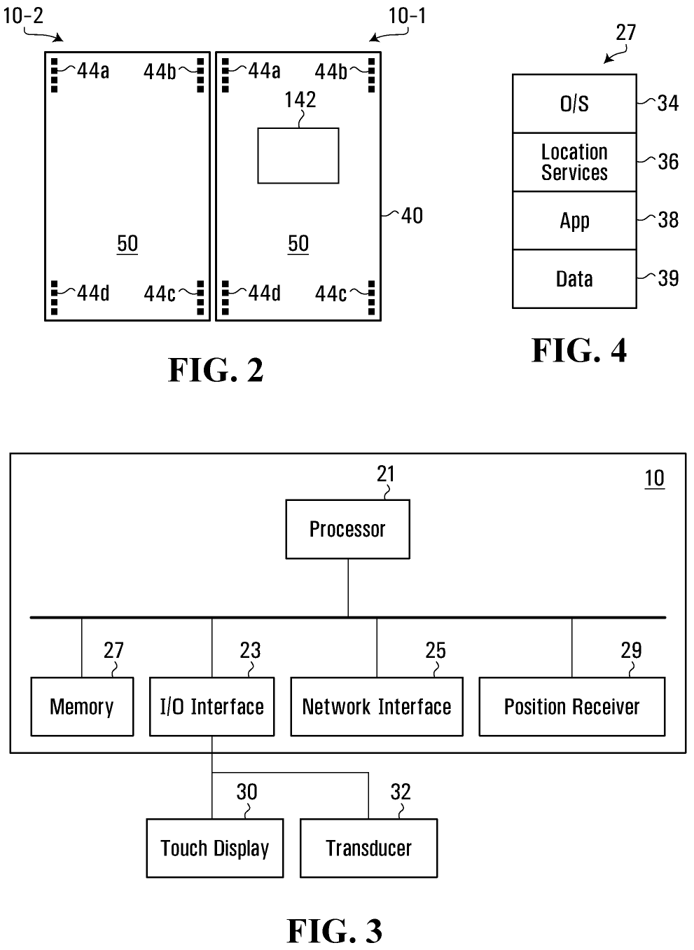

FIG. 1 illustrates a plurality of mobile devices 10-1, 10-2, 10-3, 10-4 (individually and collectively devices 10) in communication with a network 12. Example devices 10 are detailed further with reference to FIGS. 2 to 4 and may be based on devices disclosed in greater detail in U.S. Pat. No. 9,312,633.

FIG. 2 schematically depicts two such devices 10-1 and 10-2. Each device 10 may include a housing 40 defined by respective external surfaces. Device 10 can be any suitable electronic devices that interface with one another to provide complementary functions as described herein. At least one of devices 10 may be a mobile computing device. For clarity in the discussion below, mobile computing devices 10 are commonly referred to as “mobile devices” or “devices” for brevity.

Example devices include, without limitation, cellular phones, cellular smart-phones, wireless organizers, pagers, personal digital assistants, computers, laptops, handheld wireless communication devices, wirelessly enabled notebook computers, portable gaming devices, tablet computers, televisions, monitors, thermostats, speakers or any other portable electronic device with processing and communication capabilities. In at least some embodiments, devices as referred to herein can also include, without limitation, peripheral devices such as displays, printers, touchscreens, projectors, digital watches, cameras, digital scanners and other types of auxiliary devices that may communicate with another computing device.

In one example, each of devices 10 may be a smartphone, or one may be a smartphone and the other a peripheral device (e.g., a speaker, a keyboard, a display screen, a camera). In another example, one device may be a touchscreen enabled device and the other a type of communication device (e.g., a router, alarm panel, home automation interface, thermostat, or the like) for connection to other devices. As will be apparent, other types of computing devices 10 can be envisaged that benefit from interconnection and interoperability.

Further, in some embodiments, devices 10 may be of the same type—generally identical in structure and components. In other embodiments exemplified below, devices 10 (or a similar device) may interoperate with other different yet compatible devices, in a manner exemplified herein. As depicted, each device 10 include a touch display 50.

Touch display 50 may, for example, be capacitive display screens that include a touch sensing surface. Such a display may be integrated as a single component. Alternatively, touch display 50 may include suitably arranged separate display and touch components. Touch display 50 may be adapted for sensing a single touch, or alternatively, multiple touches simultaneously. Touch display 50 may sense touch by, for example, fingers, a stylus, or the like. Touch display 50 may return the coordinates of any touch or touches for use by a process or device 10. Likewise, touch display 50 may be used to display pixelated graphics—in the form of computer rendered graphics, video and the like.

In some embodiments, a composite display formed as a larger interconnected screen, allows input to be received one or more interconnected touch display 50 of another device 10.

Each of mobile devices 10 includes respective connectors 44 for allowing interconnection of devices 10. In the example illustrated in FIG. 2, device 10-1 and 10-2 includes four connectors 44a, 44b, 44c, 44d (individually and collectively connector(s) 44). Device 10-1 and 10-2 are illustrated as interconnected by way of connectors 44a and 44b.

In depicted embodiments connectors 44 are magnetic connectors capable of magnetically mechanically interconnecting devices 10 and further optionally creating an electrical connection between devices 10, as detailed in the '633 Patent.

Connectors 44 may for example be physical connectors to a serial communications port, such as a USB port, or the like. In a particular embodiment, connectors 44 may be magnetic connectors, as detailed in PCT Publication No. WO 2015/070321, the contents of which are hereby incorporated by reference.

Although connectors 44 have been shown at the corners of each edge of device 10, other location of connectors 44 may be envisaged. For example, connectors on each of devices 10 can be located at the centre of the top, bottom, left and right edges of the devices, as for example illustrated in U.S. patent application Ser. No. 15/013,750, the contents of which are hereby incorporated by reference. Additionally, although four connectors have been shown, the number of connectors provided on devices 10 may vary from device to device, and may depend on the type of device.

Devices 10-1 and 10-2 shown in FIG. 2 have been illustrated in combination, with particular exemplary connector and device form factor and geometry. Of course, alternate configurations, layout, and positioning for the connectors and alternate size and layout of the devices are possible.

Similarly, although two interconnected devices 10-1, 10-2 are shown in FIG. 2, multiple (e.g., three or more) interconnected devices can be envisaged having alternate connector configurations, layout, and position and alternate size and layout of device 10. Other geometries of devices 10, for example, generally rectangular with rounded corners, oval, or rounded in shape, may be contemplated by a person skilled in the art. Example devices having different geometries are for example illustrated in U.S. patent application Ser. No. 15/013,750.

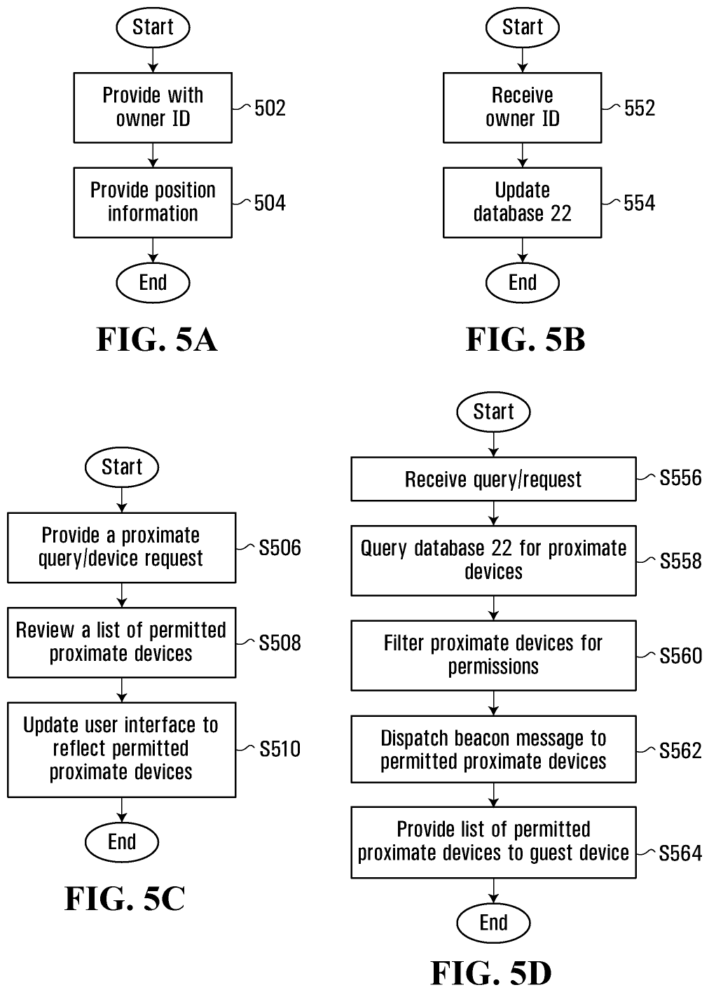

An example hardware architecture of device 10 is further detailed with reference to FIG. 3. As illustrated, device 10 includes a processor 21, processor readable memory 27, and input/output (I/O) interface 23; a network interface 25; and a position receiver 29. Device 10 may further include touch display 50; one or more audio transducers 32. Connectors 44 may be in communication with processor 21 by way of I/O interface 23.

Processor 21 may be a suitable processor forming part of processing core 42, and may include a numerical processor, and a graphics processor. In embodiments, processor 21 may be a RISC processor having an ARM based architecture, and may for example, be a suitable mobile processor manufactured by Qualcomm, Mediatek, Apple or the like. In other embodiments, processor 21 may be based on the ×86 architecture. In yet other embodiments, processor 21 may be a custom processor.

Device 10 further includes a position receiver 29. In the depicted embodiment the position receiver 29 may be a receiver capable of receiving a satellite position signal, for example, from a global positioning (GPS) satellite 16 or other satellites such as one or more GNSS satellites. Alternatively, or additionally receiver 29 may receive an indoor positioning signal, from a suitable indoor positioning system (IPS). IPS systems are, for example, disclosed at https://en.wikipedia.org/wiki/Indoor positioning system. Position receiver 29 may further be capable of receiving a position signal and optionally a beacon signal from a known location. In the depicted embodiment position receiver 29 may be a relatively high accuracy location receiver—capable, for example, of determining the position of device 10 within several metres and preferably within the centimetre range. In alternate embodiments, position receiver 29 may be a combination of hardware and software capable of determining the location of device 10, using location services.

Network 12 (FIG. 1) is a packet switched network and may include several local area and wide area networks, and may include the public internet. Devices 10 may communicate with network 12 by way of a network interface which may take the form of a Wi-Fi or cellular network interface, for example, compliant with one or more wireless networking standards including the IEEE802.11 family of standards; GSM; GPRS; 3G; 4G; 5G; LTE; or similar standards.

Network interface 25 may include one or more radios for data (and optional voice) communication with a complementary wireless network, using, for example, one or more wireless networking standards including the IEEE802.11 family of standards; GSM; GPRS; 3G; 4G; 5G; LTE; or similar standards.

A server 20 hosts a database 22 that allows location registration of each of devices 10 by way of network 12. Server 20 may be a conventional database server, and may therefore include a processor, memory storing database 22, processor executable instructions to access database 22, and to perform methods detailed herein. The database may be a relational database—such as an SQL database, or other database or datastore. Database 22 stores one or more database structures (e.g. database tables) that store device identification information, device location, owner information, guest information, and permission information, as further detailed below for each device 10. As will be appreciated, database 22 may be updated periodically (i.e. at defined intervals) and will allow searching of proximate devices; devices with like Ownerl Ds; devices that allow specific guests; and other searching and manipulation of the data, using a suitable program instructions at server 20. Device identification information, owner information, guest information, and permission information may be input at use interface of a device 10, and provided to server 20. In particular, and as will become apparent, exemplary of embodiments, proximate interoperable devices 10 with suitable permission are able to locate each other through use of server 20, by dispatching suitable queries to server 20 over network 12, that are processed and responded to by server 20, as detailed herein. Interoperable, in this context, may refer to the ability of one device to communicated and/or otherwise interact with another device, either directly or indirectly. In some embodiments this may simply mean that one device can a cause another to signal its location. In other embodiments this may mean that one device (e.g. device 10-1) may control or change settings of another. In yet other embodiments, this may mean establishing a communication link or channel and/or physical or logical interconnection of the devices.

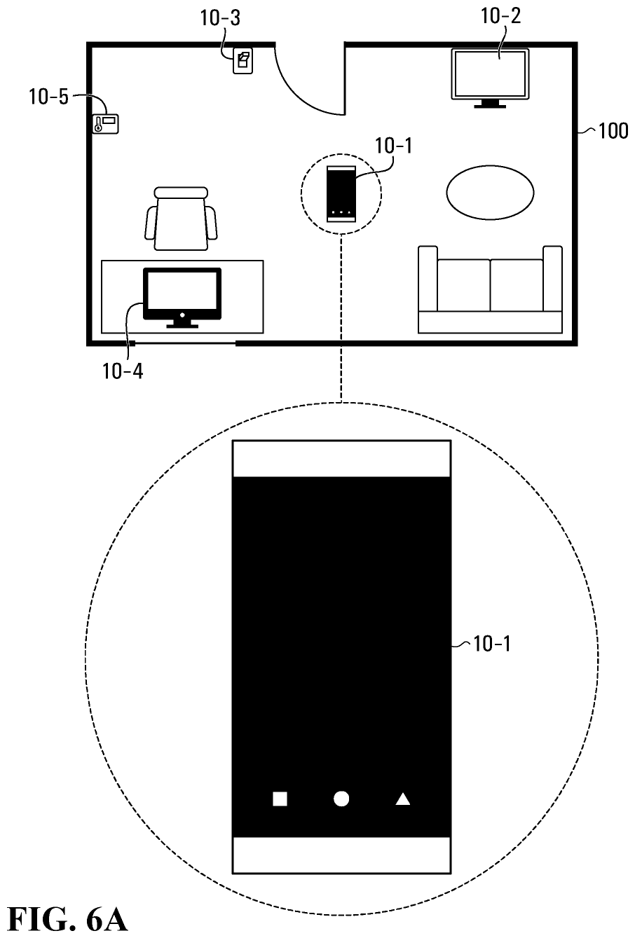

FIG. 4 illustrates an example organization of software within memory 27 of device 10. As illustrated, memory 27 may host an operating system 34; a location services application 36; user applications 38; and data 39. Operating system 34 may be Android; Linux; Windows; iOS; or similar software. It may take the form of an embedded system, or be loaded from persistent storage.

Exemplary applications within applications 38, allows devices each of devices 10 to operate in a manner desired/required by its end user. Additionally, an application within applications 38 at device 10 allows an initiating device 10 to locate other complementary devices, to allow intercommunication and optional interconnection with the other devices.

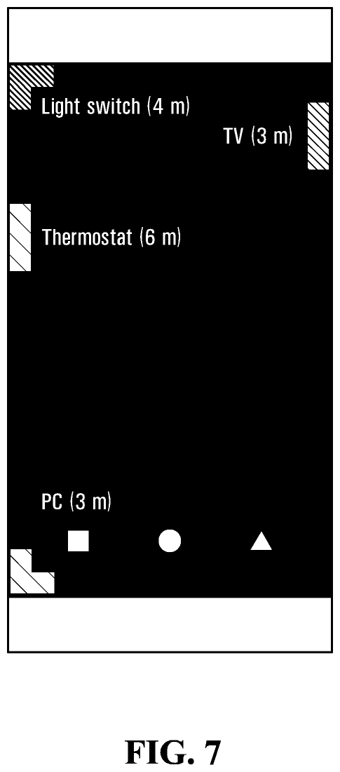

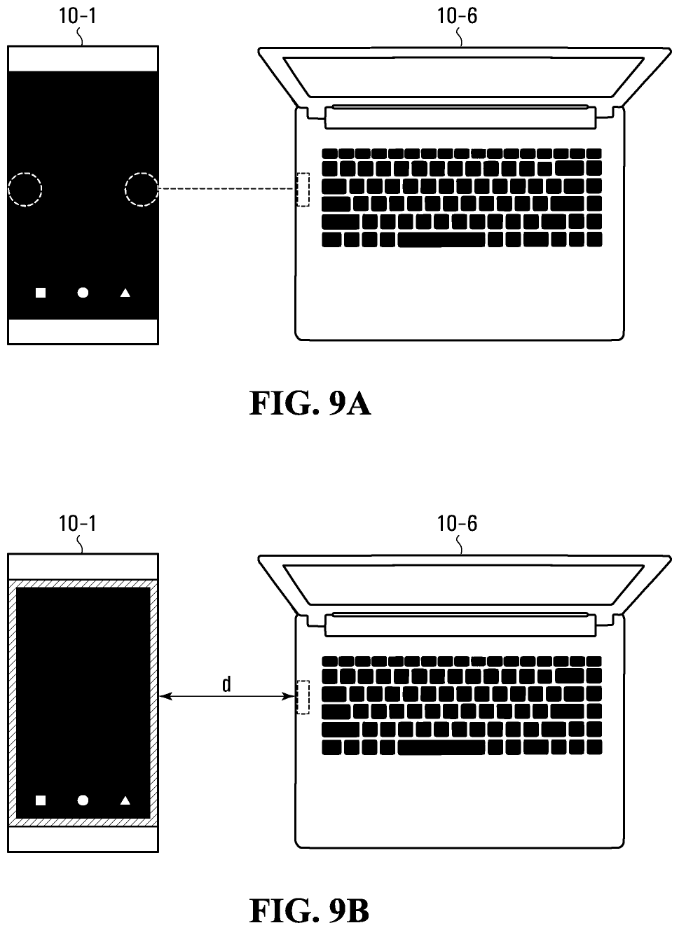

Devices 10 may for example be located in an environment 100 as illustrated in FIG. 6A-6B and 8. Within the environment of FIG. 6A, a device 10-1, acting an initiating device, may wish to locate proximate devices 10-2, 10-3, 10-4, etc. and therefore allow intercommunication with and potential interconnection with these other devices.

Environment 100 may be a house, an apartment, a room, or the other location. In the depicted embodiment device 10-1 may be a mobile device—such as a cell phone, remote control, or music player, while device 10-2, 10-3, 10-4 and 10-5 may be stationary. For example, device 10-5 may be a thermostat, device 10-2 may be a light switch, device 10-3 may be a television, device 10-4 may be a stationary computing device. Other combinations of devices 10 in an environment 100 will be apparent to those of ordinary skill.

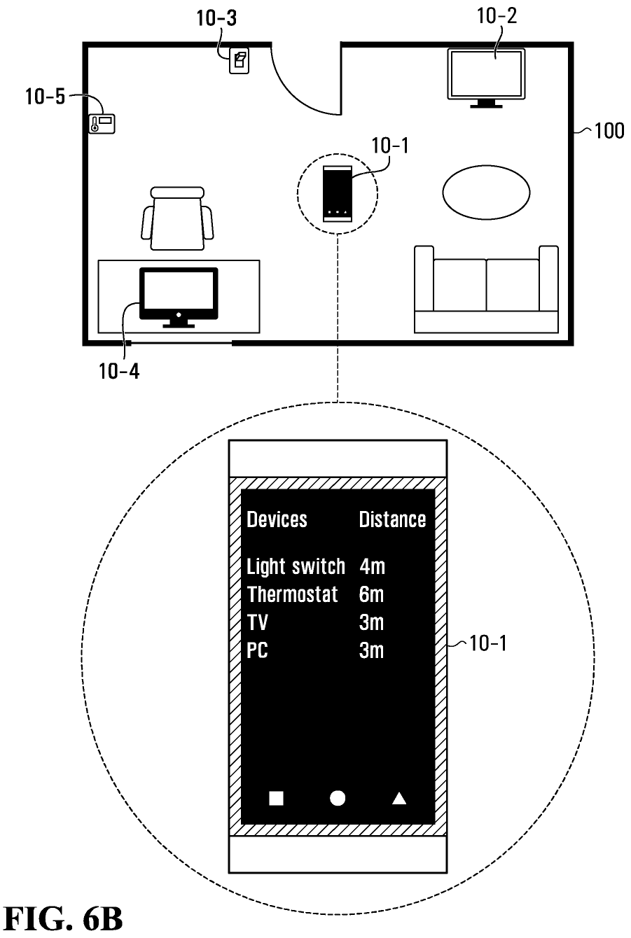

Blocks performed by device 10-1 acting as an initiating (guest) device are illustrated in FIG. 5A and 5C; blocks performed by server 20 (FIG. 1) are illustrated in FIG. 5B and 5D. In block S502, owner information may be provided by device 10-1 to server 20 that receives such information over network 12 and maintains it within database 22 in block S552 (FIG. 5B). Blocks S502 to S504 may be periodically repeated, with each of devices 10-1-to 10-4 when powered up contacting server 20 over network 12 to create a suitable record (if no such record exists) or alternatively cause their respective record to be updated. In particular, in block S504, each device 10 periodically provides its location in terms of coordinates (e.g. latitude, longitude and altitude) as gleaned from its location receiver 29, along with an optional time stamp. In addition to GPS coordinates, location data in the form of text strings that indicate the location of the device, e.g., the name of the room; name of a local area network; or the like. For example, a device 10 may be labelled “bedroom”, “kitchen”, “boardroom”, “suzy's room”, etc. Device 10 may be determined to be proximate if it is in the same room and/or proximate the same local area network. Server 20 thus stores location information specific to devices 10 within database 22, generally in real time.

Accordingly, server 20 may be queried to obtain the location or identities of other devices. A device 10 (e.g. device 10-1) may initiate such a query as illustrated in FIG. 5C. Specifically, in block S506, device 10-1 dispatches proximate device query/request to server 20. In response to receiving the query in block S556, a processor at server 20 may query database 22 in blocks S558-S560 to identify proximate devices 10 (in block S558) for which device 10-1 has access permission (in block S560). In particular, server 20 may simply locate devices 10 proximate device 10-1 (e.g. at the same location, or within a defined radius of device 10)—for example by querying devices with the radius, or proximate a similar wi-fi network, etc in block S558. Server 20 may for example identify devices 10 within a certain distance as calculated from the coordinates of device 10-1 and the remaining devices in block S558.

Additionally, or alternatively server 20 may identify which of the proximate devices 10 for which device 10-1 has access permission in block S560. For such permitted proximate devices, the GuestID or OwnerID may include the OwnerID of device 10-1, or may otherwise indicate that device 10 may access/intercommunicate with it. Permission may, of course, be otherwise indicated—either expressly or otherwise. Server 20 may further convert device location information to relative device location information allowing it to calculate which of these devices are within a defined radius of device 10-1.

Server 20 using this information may then either send an indicator of devices proximate device 10-1 to device 10-1 and /or notify those proximate devices of the query by device 10-1 in block S562 and S564 over network 12. Device 10-1 may receive the list in block S508 respond with a notification to the user that complementary devices are near in block S510, and/or otherwise update its user interface as detailed below.

For example, as illustrated in FIG. 6B, device 10-1 may respond with a visual indicator—by for example, highlighting the entire periphery of display 50 at device 10-1. By contrast, in the absence of proximate complementary devices, display 50 need not display any indicator, or an indicator that no devices are proximate (as for example depicted in FIG. 6A).

Proximate devices 10-2 to 10-5 may, for example, be identified to device 10-1 by server 20, by their device name, location (or distance—for example in meters from device 10-1), network ID, IP address, or the like.

In an embodiment, server 20 may provide one or more messages to device 10-1 that identify approximate devices by their device type and/or relative location, as for example illustrated in FIG. 6B. In an embodiment, the relative location of each of devices 10-2-10-5, proximate device 10-1, may be graphically displayed on a display 50 of device 10-1.

Additionally, proximate devices 10-2, 10-3, 10-4 and 10-5, may be signalled with a complementary message from server 20 to emit a beacon signal. The beacon signal may local—to be received at device 10-1. The beacon signal may be a radio signal, an audible, visible or other signal that may allow the locating of devices 10-2, 10-3, 10-4, and 10-5 within location by device 10-1. The complementary message may further cause devices 10-2 to 10-5 to assume a state for intercommunication with device 10-1.

Optionally, the beacon signal may be customized by the user. Customization may be effected at device 10 or optionally stored at server 20. For example, when highlighting the periphery of display 50, the colour may be associated with a particular user and may be pre-selected by the user.

The beacon signal may also be customized according to the degree of permissions granted to device 10-1 as stored at database 22, (as a guest) beacon may be different than a beacon provided to the owner. A combination of settings at device 10 and data stored in database 22 may control the nature of the beacon signal.

For example, devices 10-2 to 10-5 may emit an audible tone, vibrate, “power on” or “wake up”, etc. in response to receiving a message from server 20. Devices 10-2 to 10-5 may also optionally enter a pairing or connection mode. Device 10-1 may also be provided with the identity of one or more messages indicating proximate devices to which device 10-1 may communicate and/or interconnect.

As device 10-1 moves within location 100, its display 50 may be updated by application 38 and/or other proximate devices 10 may be signalled of movement within location 100 by server 20.

Additionally, and optionally, as location information at server 20 is updated by device 10-1, server 20 may signal other devices 10-2 to 10-5 that device 10-1 is now proximate (or more proximate). Alternatively, devices 10-2 to 10-5, more proximate may be signalled to emit higher volume sounds or more visible indicators as device 10-1 become proximate. Additionally, device 10-1 may signal relative proximity to other devices to a user by way of its user interface.

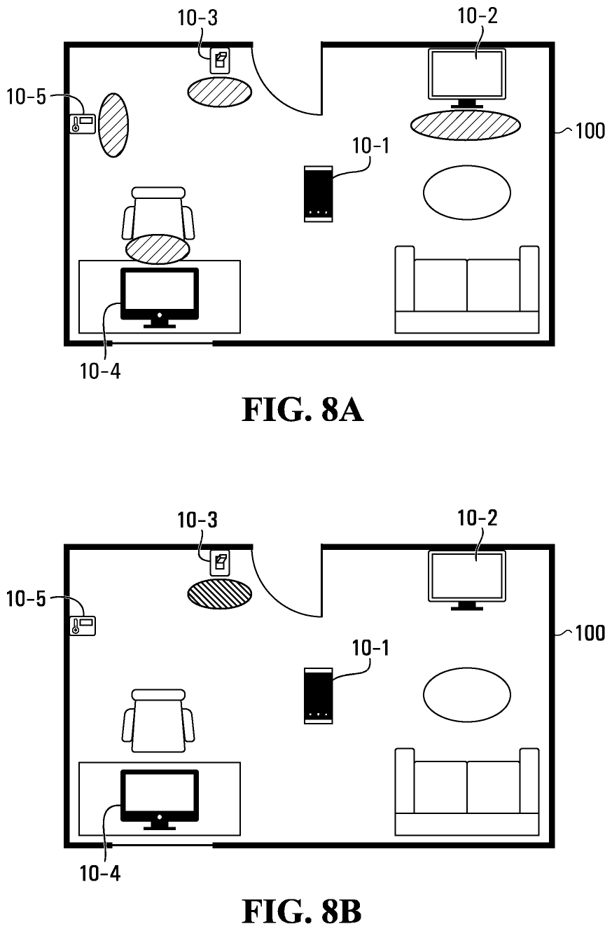

For example, as depicted in FIGS. 6A-6B, and 7, the proximity of each device may be indicated on the screen of device 10-1 and portions of the screen of device 10-1 that are most proximate to one of the other devices may be lit up. Thus, in FIG. 6A, display 50 does not identify any proximate devise. In FIG. 6B, device 10-1 illustrates that devices are proximate is indicated by lighting the periphery of screen 50 of device 10-1, and providing a list of proximate devices.

In FIG. 7 the relative location of devices 10-2-to 10-5 are indicated by bars reflective of the relative locations of these devices to the device 10-1, on screen 50 of device 10-1. Again, as device 10-1 moves, the screen may be updated to reflect movement.

Updating of display 50 may be done by processor 21 of device 10-1 calculating its relative location to other devices 10-2 to 10-5.

Of note, there may be other proximate device in environment that may not be interoperable with device 10-1 including device 10 that may not have permissions to interoperate with device 10-1. These devices, will not respond to a request to identify proximate device, initiated by device 10-1, as server 20 will not dispatch a message to such devices, nor identify them to device 10-1.

FIGS. 8A and 8B schematically illustrate devices 10-2 to 10-5 emitting an audible or visual beacon signal in response to being instructed to do so by server 20 in block S562, in response to a request by device 10-1, acting as an initiating device. As illustrated in FIG. 8A, compatible devices 10-2, 10-3, 10-4, and 10-5, in response to receiving a message over network 12 (FIG. 1) may emit a visual or audible signal perceptible by a user at device 10-1, allowing the user to physically locate devices 10-2, 10-3, 10-4, and 10-5. Optionally, closer devices may emit a more pronounced beacon signal. For example, as schematically illustrated in FIG. 8B, devices 10-2, 10-4 and 10-5 may emit an audible signal, while device 10-3 need not. Optionally, the intensity of the beacon signal may vary as device 10-1 moves within environment 100. Optionally, the beacon signal emitted by each device 10-2 to 10-5 may be controlled through interaction with a user interface at display 50 of device 10-1, thus allowing a user of device 10-1 to pinpoint the location of a particular device 10.

Once device 10-1 is sufficiently proximate to one of the other devices (e.g. device 10-2), device 10-1 may establish a communication channel that is point to point with a proximate device and/or be physically interconnect to the proximate device. For example, connectors 44 of devices 10-1 and 10-2 may be interconnected as in FIG. 2, and devices 10-1 and 10-2 may establish an electrical connection and/or a communication link as described in the '633 Patent. Alternatively, the point-to-point communication channel may be established using near field communication (NFC); Bluetooth; or other suitable wireless protocol.

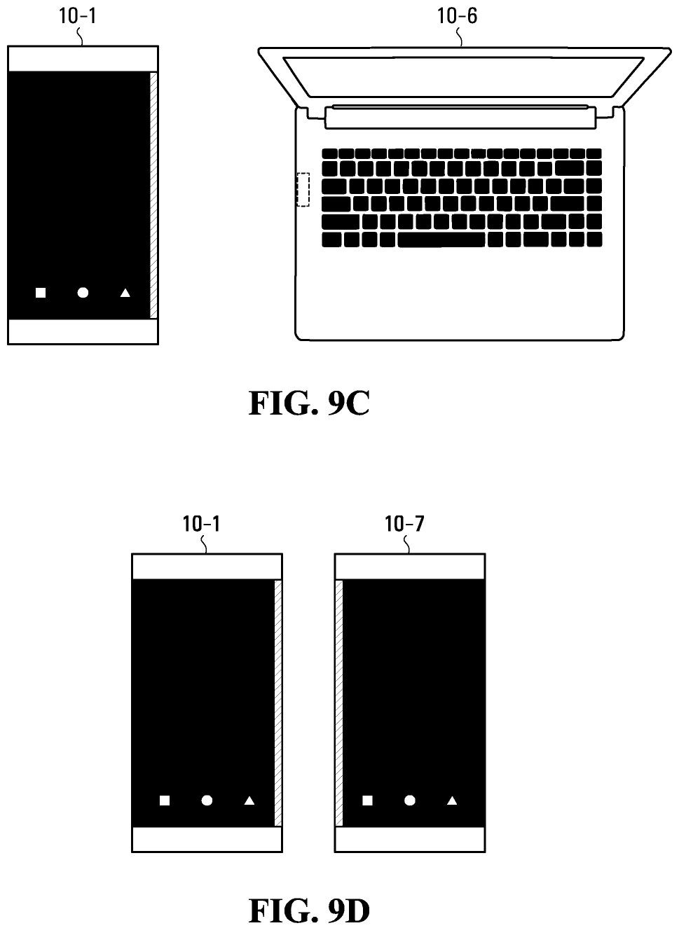

In yet other alternative embodiment, detailed in FIGS. 9A-9D, devices 10-1 and 10-6 or 10-7 (like devices 10, detailed above) may allow for their location without use of server 20. For example, as detailed in FIG. 9A, device 10-1 may sense proximity of device 10-6 by use of a proximity sensor—in the form of a hall effect sensor; magnetic sensor; RF sensor; or the like. In response to sensing device 10-6, device 10-1 may update its screen 50 as described above to signal proximity of device 10-6.

Of course, the above described embodiments are intended to be illustrative only and in no way limiting. The described embodiments are susceptible to many modifications of form, arrangement of parts, details and order of operation. The invention is intended to encompass all such modification within its scope, as defined by the claims.

What is claimed is:

1. A method of locating interoperable devices at a location, comprising:
receiving from a guest device at the location, a query over a network to a location server, said query including an indicator of location of said guest device, and an identifier of said guest device;
querying a data store, to identify a set proximate interoperable devices at the location, using said indicator of location;
identifying permitted proximate interoperable devices from said set of proximate interoperable devices, for which contact permission by said guest device has been granted; and
dispatching a message over said network to each said permitted proximate interoperable device, causing each said permitted proximate device to emit a beacon signal, that is audible or visible at said location.

2. The method of claim 1, further comprising dispatching from said location server to said guest device, a list of said permitted proximate interoperable devices.

3. The method of claim 1, further comprising dispatching from said location server to said guest device, a message to display a relative location of said permitted proximate interoperable devices.

4. The method of claim 3, wherein said beacon signal varies in dependence on an identity of the guest device.

5. The method of claim 3, wherein said beacon signal varies in dependence on the location of the guest device.

6. The method of claim 1, wherein said beacon signal further comprises a radio frequency signal received at said guest device.

7. The method of claim 1, wherein said beacon signal further comprises an infrared signal received at said guest device.

8. The method of claim 1, wherein said indicator of location includes a geographic indicator, obtained using a satellite signal.

9. The method of claim 1, wherein said indicator of location includes text indicative of location.

10. The method of claim 1, wherein said indicator of location includes a geographic indicator, obtained using an indoor positioning system.

11. The method of claim 1, further comprising establishing a point to point communication channel between said guest device and at least on of said proximate interoperable devices.

12. The method of claim 1, further comprising causing said guest device to present at least one indicator of relative position of said guest device to said permitted proximate interoperable devices.

13. The method of claim 12, wherein relative position of said guest device to said permitted proximate interoperable devices are generated at said guest device from said indicator of location of said guest device and an indicator of location of said permitted proximate interoperable devices.

14. The method of claim 12, wherein relative positions of said guest device to said permitted proximate interoperable devices are communicated from said server to said guest device.

15. The method of claim 12, wherein said at least one indicator of relative position comprises a graphical indicator in the direction of said permitted proximate interoperable devices.

16. The method of claim 15, wherein said graphical indicator includes illuminating a portion of a screen of said guest device proximate one of several physical connectors at said guest device, and said permitted proximate interoperable devices.

17. The method of claim 16, wherein said portion of said screen is illuminated with a brightness inversely proportional to a distance between said guest device and said permitted proximate interoperable devices.

18. The method of interconnecting first and second devices, each including a physical connector, said method comprising:
sending from said first device a near range query signal;
receiving from a second device, an indicator that said second device is within a defined proximity of said first device;
generating at said first device, an indicator of relative position of said second device to said first device, to allow said first device to be guided to said second device for interconnection by way of its physical connector.

19. The method of claim 18, wherein said receiving comprises receiving said indicator at one of multiple sensors at said first device, wherein that one of said sensors allows said first device to determine a relative position of said second device.

20. The method of claim 18, wherein said indicator allows said first device to approximate at least one of distance and relative location to said second device.

21. The method of claim 20, wherein said indicator comprises an indicator of position derived from a satellite signal.

22. The method of claim 21, further comprising emitting at least one of a visible or audible indicator that said second device is in proximity at said first device.
